(19) United States
(12) Patent Application Publication
(10) Pub. No.: US 2004/0212248 A1
(43) Pub. Date: Oct. 28, 2004

(54) Hydraulic braking device with improved brake sensitivity

(76) Inventor: Leonardo Cadeddu, Crema (IT)

Correspondence Address: Leo H. McCormick Jr., 2112 Mishawaka Avenue, P.O. Box 4721, South Bend, IN, 46634, US

(21) Appl. No.: 10/424,294

(22) Filed: Apr. 28, 2003

(51) Int. Cl. B60T 8/44

(52) U.S. Cl. 303/114.1; 188/358

(57) ABSTRACT

A hydraulic braking device for a self-propelled vehicle, particularly for agricultural vehicles, for example tractors comprising a master cylinder and a hydraulic brake booster. An actuating rod is mounted to sealingly, slide within a hydraulic boost piston that separates a hydraulic boost chamber into a front chamber and a rear chamrber. At rest the first and second chambers are in communication and filled with a same hydraulic fluid at high pressure. During a brake application, communication between the front and rear chambers is interrupted and the high pressure fluid in the front chamber communicatecd to a pressure chamber in the master cylinder to initiate a brake application and to allow the high pressure fluid in the rear chamber to act on the boost piston and develop a force that acts on an operating piston to further develop pressurized fluid in the pressure chamber during the brake application.

The present invention relates mainly to an improved sensitivity hydraulic braking device for a self-propelled vehicle, particularly for agricultural vehicles, for example tractors.

### BACKGROUND OF THE INVENTION

Hydraulic braking device comprising a master cylinder equipped with at least one piston operated by an actuating rod connected to a brake pedal, action on the brake pedal being boosted by a hydraulic brake booster of the so-called “closed center” type equipped with a hydraulic piston supplying the assistance, the braking device also comprising a high-piressure fluid accumulator, are known. At rest, the communication between the “closed center” hydraulic brake booster of known type and the accumulator is interruipted upstream of the hydraulic piston of the booster and the booster is filled with hydraulic fluid at low pressure. During braking, the communication between the booster and the accumultor opens and the hydraulic fluid at high pressure contained in the accmulator, flows into the brake booster causing the hydraui boost piston to move towards the master cylinder and hydraulically boosting the braking. The pressure iaccumnulator is fed, for example, by a hydraulic pump.

This “closed center” type of booster has the disadvantage that it does not allow fine control of the amount of braking desired because of the flow of liquid under pressure in the booster, something whichoit felt by the driver as sharp braking.

In addition, this known closed center type of booster offers a very unpleasant brake pedal feel which the driver of the vehicle is sure to find uncomfortable.

### SUMMARY OF THE INVENTION

It is therefore an object of the present invention to offer a hydraulic braking device that allows better control of the degree of braking.

Another object of the present invention is to offer a hydraulic braking device in which the reaction transmitted to the brake pedal gives a piedal feel that is pleasant for the driver.

This object is achieved through a hydraulic braking device comprising a master cylinder and a “closed center” hydraulic brake booster, the communication between the hydraulic brake booster and the source of hydraulic fluid at high pressure being closed downstream of the hydraulic boost piston.

In other words, this is a hydraulic braking device comnprising a master cylinder and a hydraulic brake booster comprising a body in which, is mounted to slide with sealing a hydraulic boost piston, said boost piston separating a first chamber from a second chamber; at rest, said chambers are in communication and filled with a hydraulic fluid at high pressure, and during a braking phase, the comnmunication between the two chambers is interrupted and the communication between the second chamber and the master cylinder is opened, causing the boost piston to move.

The hydraulic device according to the present invention has the advantage of aliowing functional clearances in the braking circuit, for example at the vehicle wheel brakes, to be closed up at the very start of braking. These functional clearances are closed up in a way that is invisible to the driver, thus eliminating the impression of a braking lag.

The main subject of the ievention is a hydraulic braking device comprising a master cylinder and a hydraulic brake booster, said master cylinder comprising at least one hydraulic piston defining a pressure chamber connected to brakes at the vehicle wheels, said hydraulic brake booster comprising a boost piston dividing a chamber into a first chamber and into a second chamber, means for establishing communication and means for interrupting the communication between the chambers, said braking device being actuated by an actuting rod connected to a brake pedal and moving an operating piston mounted to slide with sealing in the boost piston, said device also comprising a source of hydraulic fluid at high pressure feeding said hydraulic brake booster, characterized in that, at rest, the rear chamber and the front chamber of the hydraulic brake booster are placed in communication and filled with hydraulic brake fluid at roughly the same pressure supplied by the high-pressure source of hydraulic fluid.

Another subject of the invention is a braking device characterized in that the piston has a skirt fixed to a rod driven by the actuating rod.

Another subject of the invention is a braking device characterized in that the communication between the chamber of the hydraulic booster and the chamber of the master cylinder is via ducts and a system of valves.

Another subject of the invention is a braking device characterized in that the system of valves comprises a first valve equipped with a shutter collaborating with a valve seat actuated by a push-rod as the operating piston moves in the rod of the hydraulic boost piston and a second valve equipped with a shutter collaborating with a seat actuated by a difference in hydraulic pressure between the chamber of the hydraulic booster and the chamber of the master cylinder.

Another subject of the invention is a braking device characterized in that the rod of the hydraulic boost piston comprises a first part of larger outside diameter facing toward the brake pedal and a second part of smaller relative outside diameter, axially opposed to the first part.

Another subject of the invention is a braking device characterized in that it comprises an exhaust chamber able to be placed in communication with the front chamber of the hydraulic booster by first comrmunication means and with the chamber of the master cylinder by second communication means.

Another subject of the invention is a braking system characterized in that it comprises two braking devices as described hereinabove, connected by a pressure-equalizing device.

The present invention will be better understood with the aid of the description which follows and with the attached drawings in which the front and the rear correspond respectively to the left and to the right of the drawings.

### BRIEF DESCRIPTION OF THE DRAWINGS

FIG. 1 is a view in longitudinal section of a hydraulic braking device according to the present invention, in the rest position;

FIG. 2 is a view in section of a hydraulic braking device of FIG. 1 in a first braking position; and

FIG. 3 is a view in longitudinal section of the hydraulic braking device of FIG. 1 in a second braking position.

### DETAILED DESCRIPTION OF THE INVENTION

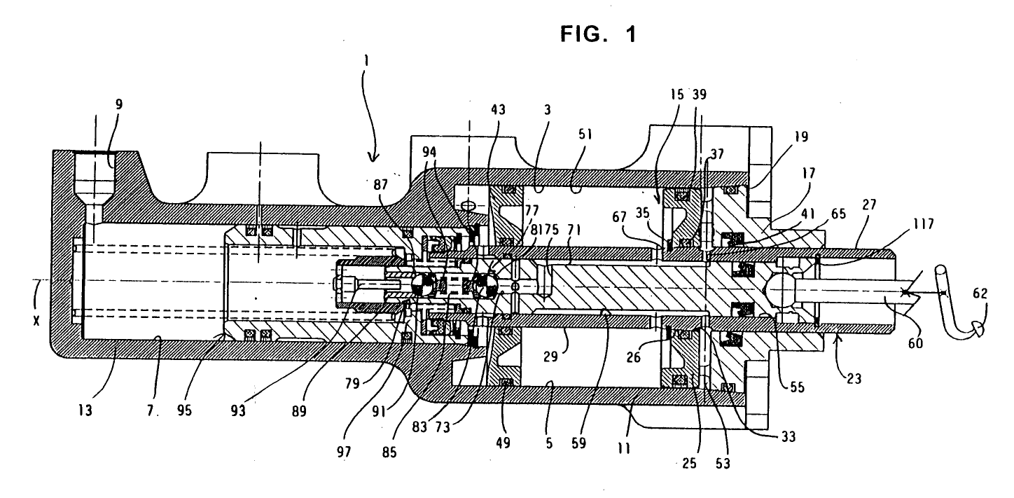

FIG. 1 shows a hydraulic braking device D1 according to the present inivention comprising a body 1 of axisymmetric overall shape and of axis X. The body 1 is pierced with a bore 3 formed at the rear by a larger-diameter first chamber 5 and at the front by a smaller-diameter second chamber 7. The first chamber 5 forms a hydraulic brake booster, the second chamber 7 forms a master cylinder 13, the chamber 7 being connected to at least one brake at the wheels by a duct 9 made at right angles to the axis X in the body 1. The hydraulic booster 11 comprises a hydraulic boost piston 15 mounted to slide with sealing in the chamber 5, the piston 15 beingn guided in translation along the axis X by a ring 17 closing off a rear longitudinal first end 19 of the chamber 5. The hydraulic boost piston 15 comprises a rod 23 to which a skirt 25 is fixedly mounted, the rod 23 formed of a tube comprising, at a longitudinal first end facing towards the rear, a larger-diameter first part 27 and, at a longitudinal second end facing toward the front, a smaller-diameter second part 29, the larger-diameter first part 27 being connected to the smaller-diameter second part 29 by a conical section 26 the cone vertex of which faces forward, able to collaborate with an orifice 33 of conical longitudinal section made in the central part of the skirt 25. In consequence, the skirt 25 is secured to the rod 23 towards the rear by the collaboration of the conical section 26 and of the passage 33, and towards the front by a circlip 35. Sealing between the rod and the skirt is achieved by means of a seal, for example an O-ring 37, sealing between the skirt 25 and the interior periphery of the chamber 5 is achieved by means of a seal, for example. an O-ring 39, and sealing between the rod and the ring 17 is achieved for example by means of seals, for example lip seals 41. The front longitudinal end of the rod 23 sealingly enters the chamber 7 of the master cylinder, sealing between the chamber 7 and the chamber 5 being achieved by a ring 43 having a passage 45 in which the rod 23 slides with sealing, the sealing being afforded by seals, for example an O-ring, the ring 43 being mounted fixedly, for example forcibly, in the chamber 5 in a sealed way, sealing being achieved using a seal, for example an O-ring 49.

The skirt 25 divides the chamber 5 into a rear first chamber 53 and a front second chamber 51. The rod 23 defines a passage 55 in which there is mounted to slide with sealing an operating piston 59 equipped at a first end, facing the rear, with an actuating rod 60 connected to an actuating means, for example a brake pedal 62. The front chamber 51 and the rear chamber 53 are, at rest, placed in communication via the bore 55 and ducts 65, 67 made in the rod 23 at right angles to the axis X.

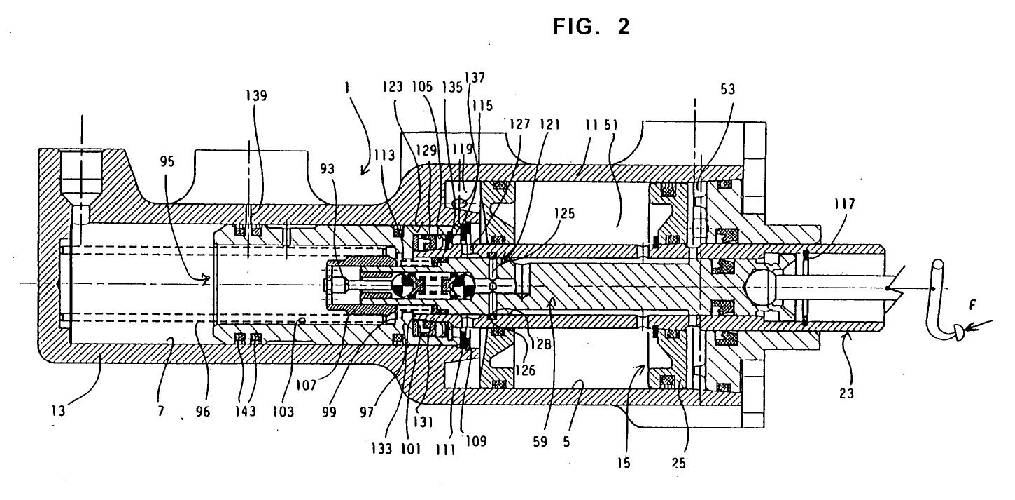

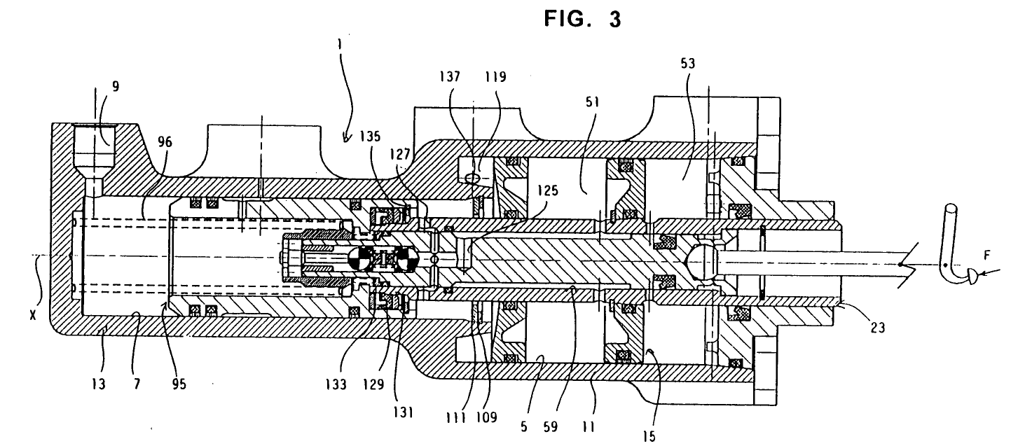

The operating piston 59 comprises means 69 of comrnmunication between the front chamber 51 and the chamber 7 of the master cylinder, the communication means 69 are formed of ducts 71 made on the exterior periphery of the operating piston 59 and parallel to the axis X, of a bore 73 made in the longitudinal front part of the operating piston 59 and connected to the duct 71 by a transverse passage 75. The bore 73 made in the front part of the operating piston 59 comprises a first valve 77 and a second valve 79, in the non-limiting example depicted in FIGS. 1, 2 and 3, the first valve 77 is hydraulically operated, the second valve 79 being mechanically operated.

The first valve 77 comprises a valve seat 81 formed, for example, of a shoulder made in the interior periphery of the bore 73 and a shutter formed for example of a ball 83, the ball 83 being pressed against the valve seat 81 by a spring 85. The second valve 79 is formed of a valve seat 87 formed of a longitudinal first end of a sleeve 89 forcibly. mounted in the front part of the bore 73 and a shutter, for example a ball 91, applied to the valvti seat 87 by the spring 85. The valve 79 is opened by means of a rod 93 mounted fixedly with respect to a hydraulic piston 95 of the master cylinder 13. The spring 85 is mounted in compression between the first ball 83 and the second ball 91 via a first and a socond bearing means 94. The master cylinder 13 comprises a hydraulic piston 95 mounted to slide with sealing in the chamber 7 of the master cylinder for example by means of O-rings arranged in grooves made in the exterior periphery of the piston 95. The piston 95 is more or less socket-shaped, its interior periphery having an annular projection 97 in which the front end of the operating piston 59 slides. The annular projection 97 forms a front shoulder 99 and a rear shoulder 101 dividing the inside of the socket into a front part 103 of smaller inside diameter and a larger-diameter rear part 105.

The rod 93 for mechanically opening the second valve 79 arranged in the operating piston 59 is carried by a sleeve 107 the rear end of which forms a base trapped between the shoulder 99 and a spring 96 mounted in compression in the chamber 7. The spring 96 is a spring for returning the hydraulic piston 95 to the rest position, the longitudinal rest position of the piston 95 being defined by a stop 109, for example a circlip, rhounted in a groove made in the internal periphery of the chamber 7, a seal, for example a flat seal 111 is mounted to bear between the cirlip 109 and the rear longitudinal end of the piston 95. The return spring 113, when the operating piston 59 is in the rest position, is mounted between a rear longitudinal and of the sleeve 107 and a shoulder 115 made on the exterior periphery of the operating piston 59, the rest position of the operating piston being defined by a stop 117, for example a circlip, mounted in a groove made in the internal periphery of the rear part of the bore 55 of the rod 23.

The chamber 5 comprises an exhaust chamber 119 delimited by the second guide ring 43 and by a part of the body 1 projecting into the chamber 5 and forming a rear longitudinal end of the chamber 7. The exhaust chamber 119 is able to be placed in communication with the front chamber 51 and the chamber 7 of a master cylinder via, respectively, first 121 and second 123 communication means. The first communication means 121 comprises a first exhaust duct 125 made in the operating piston 59 at right angles to the axis X and opening into the bore 73 and into the exterior surface of the operating piston 59, and also comprises second exhaust ducts 127 made in the rod 23 of the boost piston 15 at right angles to the axis X and opening into the exhaust chamber and into the bore 55. Comrnunication between the first exhaust ducts 125 and the second exhaust ducts 127 can be interrupted by a seal 126, for example an O-ring mounted fixedly in a groove 128 made in the internal surface of the rod 23.

The second means 123 able to place the chamber 7 of the master cylinder and the exhaust chamber 119 in communication, comprise a lip seal 129 mounted in the larger-diameter rear part 105 of the hydraulic piston 95 of the master cylinder, able to intercept a larger-diameter rear portion 131 of the front longitudinal end of the rod 23 relative to a smaller-diameter front portion 133, the smaller-diameter portion 133 extending over a length L. The lip seal 129 is held in position by a stack of rings 135 and by a stop, for example a circlip, mounted in a groove made in the internal periphery of thb larger-diameter rear part 105 of the hydraulic piston 95. The exhaust chamber 119 comprises an exhaust orifice 137 allowing the brake fluid to be returned to a brake fluid reservoir (not depicted).

This first device D1 is advantageously associated with an identical second device, in a brake system for a tractor (not shown). Each device is connected to a separate wheel brake associated with a wheel axle and a pressure balancing device (not shown) located between the devices to equalize pressures there between. A communication duct 139 made in the wall of the chamber 7 of each master cylinder at right angles to the axis X and a second communication duct 141 made in the hydraulic piston 95 in the smaller-diameter part 10 provides commnunication between the first and second devices D1, and the balancing device. The duct 139 is isolated from the chamber 7, and therefore from the-brake fluid by two seals, O-rings 143 mounted in grooves made in the exterior periphery of the piston 95. During braking, the chambrer 7 is placed in communication with the duct 139 via the duct 141, the seals 143 having traveled beyond the axial position of the duct 137 through the advance of the piston 95, no longer provide sealing between the duct 137 and the chamber 7.

The first and second devices D1 are each actuated :by a respective separate actuating means, for example a pedal 62, connected to the actuating rod, it being possible for the pedals to be actuated sirnultaneoutsly by removable connecting means. When a tractor is equipped with first and second devices D1 when driven along a road rather than over agricultural land, for example a field, the pedals 62 are connected together and can be actuated together so as to brake both tractor wheel axles. When moving around a field, the pedals 62 can be actuated independently so as to assist with the movement of the tractor in bends bv.applying a braking action that can differ across the two axles.

The device also comprises a source (not depicted) of hydraulic fluid at high pressure of roughly between 15 and 30 bar and advantageously between 18 and 20 bar, fed to the hydraulic brake booster. The source, for example comprising a pressure accumulator fed via a hydraulic pump, is in constant communication with the rear chamber 53 of the booster. In cionsequence, in the rest phase, the rear chamber 53 and the front chamber 51 are filled with hydraulic fluid of the same pressure originating from the high-pressure fluid source.

We shall now describe the way in which the hydraulic braking device according to the present invention works.

At rest, as illustrated in FIG. 1, the operating piston 59 bears against the stop 117. The relative position of the operating piston 59 and of the rod 23 or more particularly that of the transverse duct 65 of the rear chamber 53 and the position of the longitudinal duct 71 of the operating piston 59, allows communication between the rear chamber 53 and the front chamber 51 via the duct 65, the duct 67 and the duct 71. Communication between the front chamber 51 of the hydraulic booster and the chamber 7 of the master cylinder 13 is interrupted by the system of valves 77, 79 which is arranged in the front part of the longitudinal end of the operating piston 59.

Comnmunication between the front chamber 51 of the hydraulic booster 11 and the exhaust chamber 119 is interrupted by the O-ring 126 mounted in the groove 128 made in the interior periphery of the rod 23, the O-ring 126 being arranged between the first exhaust duct 125 made in the body of the operating piston 59 and the second exhaust duct 127 made in the body of the rod 23.

Communication via the means 123 between the chamber 7 and the exhaust chamber 119 is open, the lip seal 129 at rest not intercepting the larger-diameter rear portion 131.

When the driver performs a braking action, he depresses the brake pedal which moves the actuating rod 60, moving the operating piston 59 axially forward. The relative movement of the operating piston 59 with respect to the rod 23 interrupts the communication between the rear chamber 53 and the front chamber 51 of the hydraulic booster. What actually happens is that the portion of the hydraulic piston 59 that is situated behind the ducts 71 intercepts duct 65 as the operating piston 59 moves forward. The axial movement of the piston 59 with respect to the hydraulic piston 95 of the master cylindc 13 causes the second valve 79 to open by the pressing of the rod 93 secured to the sleeve 107 mounted fixed with respect to the hydraulic piston 95 on the ball of the second valve seat 79, the ball 91 lifting off the valve seat 87 against the action of the spring 85.

The difference in pressure between the front chamber 51 of the hydraulic booster 11 and the chamber 7 of the master cylinder causes the first valve 77 to open, the ball 83 on the first valve seat 77 lifting off the valve seat 81 against the action of the spring 85. In consequence, the hydraulic fluid contained in the front chamber 51 under a high pressure relative to the hydraulic fluid contained in the chamber 7, flows through the communication means 69 into the chamber 7, more particularly, the fluid-flows from the chamber 51 to the chamber 7 through the duct 67, the duct 71, the transverse bore 75 and the bore 73 made in the front part of the longitudinal end of the operating piston 59 through the first and second valves 77, 79, which are open.

There is therefore a reduction in pressure in the front chamber 51 of the hydraulic booster, and in consequence there is forward axial movement of the hydraulic boost piston 15 because of the difference in pressure between the rear chamber 53 aind the front chamber 51.

Up to this moment, the brake fluid has been flowing into the exhaust chamber 119 through the communication means 123, preventing pressure from appearing in the chamber 7. However, the pressure of the fluid contained in the chamber 7 and in the brake circuit is high enough to allow the functional clearances of the braking circuit to be taken up.

Thereafter, the advance of the boost piston 15 causes the closing of the second communication means 123, through the advance of the rod 23 of the boost piston 15 with respect to the lip seal 129 mounted fixedly, in the hydraulic piston of the master cylinder 95. Once the boost piston 15, and therefore the rod 23, have moved axially forward, the lip seal 129 intercepts the larger-diameter rear portion 131, sealingly tupting the communication between the chamber 7 of the master cylinder and the exhaust chamber 119 and allowing the pressure in the chamber 7 of the master cylinder 15 to rise and the master cylinder to exert a reaction on the operating piston 59 by applying a brake fluid pressure to the front transverse end of the operating piston 59, this reaction adding to the reaction offered by the spring 116.

There is therefore a relative movement between the rod 23 of the hydraulic boost piston 15 and the operating piston 59, more particularly the hydraulic piston 15 has a position further advanced with respect to the operating piston 59, and the re-opening of the communication between the rear chamber 53 and the front chamber 51 of the hydraulic booster and therefore a supply of high-pressure brake fluid to the front chamber 51.

Next, as the pressure in the chamber 7 of the master cylinder combines with the reaction of the spring 85, this closes the first valve 77 by pressing the ball 83 onto the seat 81.

The relative movement between the boost piston 15 and the operating piston 59 causes the opening of the first communication means 121, by placing the.first exhaust duct 125 of the operating piston 59 in communication with the second exhaust duct 127 of the rod 23. The high-pressure hydraulic fluid contained in the chamber 51 of the hydraulic booster therefore flows through the first communication means 121 into the exhaust chamber 119. This causes a difference in pressure between the rear chamber 53 and the front chamber 51 of the hydraulic booster and therefore causes the boost piston 15 to advance. The forward axial movement of the boost piston 15 causes, through the bearing of the front longitudinal end of the rod 23 on the rear shoulder 101 borne by the annular projection 97 of the hydraulic piston 95, the forward axial movement of the hydraulic piston 96 and an increase in the pressure in the chaimber 7, in the braking circuit allowing braking. The pressure in the chamber 7 of the master cylinder 13 is proportional to the force applied to the brake pedal by the driver, in accordance with the following formula (I):.

F−F2−F3=(P3*A7)+F1−[P53*(A51−A27)]+[P51*(A51−A29)] (I)

F being the force applied by the pedal, F2 being the load on the spring 116, F3. being the reaction of the spring 85, P3 being the pressure in the chamber 7, A3 being the cross-sectional area of the hydraulic piston 95, F1 being the reaction of the return spring 113, P53 being the pressure in the rear chamber 53, P51 being the pressure in the front chamber 51, A7 being the cross-sectional area of the chamber 7, A51 being the cross-sectional area of the front chamber 51 and also that of the :chamber 53, A29 being the cross-sectional area of the smaller-diameter part 29 of the 10 rod 23 and A27 being the cross-sectional area of the larger-diameter part 27 of the rod 23.

The boosting afforded by the hydraulic booster will increase with the force F and the pressure in the chamber 7 of the master cylinder in accordance with formula (I) until the moment when the pressure in the front chamber 51 of the booster is equal to atmospheric pressure. The device then enters saturation phase. In this saturation phase, any variation by the driver of the force F on the brake pedal causes a variation in pressure P in the chamber 7 of the master cylinder equal to:

P=F/A7

The return of the device according to the present invention to the rest position is as follows: the driver releases the brake pedal, which, under the action of the spring 116, causes the operating piston 59 to return to the rest position and the second valve 79 to close, and causes the reopening of the communication between the rear chamber 53 and the front chamber 51 and therefore the re-equalizing of the pressures between the chamber 53 and the chamber 51 and causes the boost piston 15 to be returned to the rest position.

The device according to the present invention is now ready for a further braking phase.

Should the high-pressure brake fluid source malfunction, the device operates like a conventional master cylinder without boost. When the driver depresses the brake pedal, the rear end of the operating piston 59 comes to bear against a shoulder formed on the internal periphery of the bore 51 of the rod 23, moving the rod 23 and closing the conimunication between the chamber 7 of the master cylinder and the exhaust chamber 119 by the interception of the seal 129 by the longitudinal end of the rod 23. The front longitudinal end comes to bear against the rear shoulder 101 formed on the internal periphery of the piston 95 and moves the piston forward. The advance of the piston has the consequence of sending brake fluid to the brakes, the valve 77 being closed because it is not subjected to a pressure difference and because the communication between the chamber 7 of the master cylinder and the :exhaust chamber 119 is closed.

We have indeed produced a braking device allowing progressive braking, by flow, proportional to the braking force applied by the driver to the brake pedal, of the high-pressure hydraulic fluid into the chamber 7 of the master cylinder and into the braking circuit via the duct 9, and which offers the driver a pleasant pedal feel.

Of course, the use of any type of valve other than the ball valves 77 and 79 does not constitute departure from the scope of the present invention.

The difference in cross section between the larger-diameter first-part 27 of the rod 23 situated behind the skirt 25 and the smaller-diameter second part 29 of the rod 23 situated in front of the skirt 25 advantageously makes it possible to keep the boost piston 15 in a backward position of rest. This obviously saves adding a return spring to the device of the present invention.

The present invention applies in particular to the agricultural-vehicle industry.

The present invention applies mainly to the agricultural-vehicle braking system industry.

I claim:

1. A hydraulic braking device comprising a master cylinder (13) and a hydraulic brake booster (11), said master cylinder comprising at least one hydraulic piston (95) defining a pressure chamber (7) connected to brakes at the vehicle wheels, said hydraulic brake booster comprising a1 boost piston (15) dividing a boost piston charnber (5) into a first chamber (53) and into a second chamber (51), eans for establishing communication and means for interrupting the comnmunication (65, 67, 71) between the chambers (53, 51), said braking device being actuated by an actuating rod (60) connected to a brake pedal (62) and moving an operating piston (59) mounted to slide with sealing in the boost piston (15), said device being connectd to a sorce of hydraulic fluid at high pressu a feeding said hydraulic brake booster, characterized in that, at rest, the rear chamber (53) and the front chiamber (51) of the hydraulic brake booster (11) are placed in commdunicaition and filled with hydraulic broke fluid at roughly the same pressure supplied by the high-pressure source of hydraulic fluid and on said actuating rod (60) being moved by said brake pedal (62) said means for interrupting being actuated to allow said hydraulic brake fliud in said front charnber (51) to be communicated to said pressure chamber (7) and initiate a brake application and thereafter said pressure of said hydraulic braike fluid in said rear chamber (53) acts an and moves said boost piston (15) to create a force for moying said hydraulic piston (95) in said pressure chamber (7) to further develop pressurized fluid to effect said brake application.

2. The braking device according to claim 1, characterized in that the piston (15) has a skirt (25) fixed to a second rod (23) driven by the actuating rod (60).

3. The braking device according to claim 1, chrakcteized in that the communication between the boost piston chamber (5) of the hydraulic booster and the pressure chamber (7) of the master cyrlinder is via ducts (71, 73, 75) and a system of valves (77, 79, 93).

4. The braking device according to claim 3, characterized in that the system of valves comprises a first valve (79) equipped with a shutter (91) collaborating with a valve seat (87) actuated by a push-rod (93) as the operating piston (59) moves in the second rod (23) of the hydraulic boost piston (15) and a second valve (77) equipped with a shutter (83) collaborating with a second seat (81) actuated by a difference in hydraulic pressure between the boost piston chamber (5) of the hydraulic booster and the chamber (7) of the master cylinder.

5. The braking device according to claim 2, characterized in that the second rod (23) of the hydraulic boost piston comprises a first part (27) of larger outside diameter facing toward the brake pedal (60) and a second part (29) of smaller relative outside diameter that is axially opposed to the first part (27).

6. The braking device according to claim 5, characterized in that it comprises an exhaust chamber (119) that is placed in communication with the front chamber (51) of the hydraulic booster by first communication means (121) during a brake application and with the pressure chamber (7) of the master cylinder on termination of a brake application by second communication means (123).

7. (Deleted).
